(19) United States
(12) Patent Application Publication
(10) Pub. No.: US 2024/0325936 A1
(43) Pub. Date: Oct. 3, 2024

(54) PORTABLE GAMING MONITOR

(71) Applicant: UPSWITCH, LLC, Wilmington, DE (US)

(72) Inventors: Dean Thomas Mercier, Issaquah, WA (US); John Smith, Salisbury, MD (US)

(73) Assignee: UPSWITCH, LLC, Wilmington, DE (US)

(21) Appl. No.: 18/573,855

(22) PCT Filed: Jun. 23, 2022
(86) PCT No.: PCT/US2022/034783

§ 371 Date: Dec. 22, 2023

Related U.S. Application Data
(60) Provisional application No. 63/214,519, filed on Jun. 24, 2021.

(51) Int. Cl. A63F 13/92; A63F 13/98

(52) U.S. Cl. CPC A63F 13/92; A63F 13/98

(57) ABSTRACT

A portable gaining monitor is configured for use with a portable video game unit that includes a base with a first screen, a processor, and a first controller detachably coupled to the base. The portable gaming monitor includes a housing and a gaming unit dock configured to receive the portable video game unit. The portable gaming monitor further includes a second screen positioned on the housing and being operably connected to the portable video game unit when the portable video game unit is received by the gaming unit dock. The portable gaming monitor also includes a first interface configured to detachably coupled the first controller to the housing. The first controller is in communication with the portable video game unit when the first controller is coupled to the first interface, and the portable video game unit when the portable video game unit is received by the gaming unit dock.

### CROSS-REFERENCE(S) TO RELATED APPLICATION(S)

This application claims priority to U.S. Provisional Patent Application No. 63/214,519 filed Jun. 24, 2021, which is incorporated by reference herein in its entirety.

### BACKGROUND

Portable gaming systems enable players to play video games in locations that are not possible with traditional gaming consoles. In order to maintain the portability of the systems, the screens are smaller than typical computer monitors or televisions on which the games are typically displayed.

FIGS. 1 and 2 show an example of a known portable gaming video game unit 50 (also referred to as a “gaming unit”). The gaming unit 50 includes a base 52 having a housing 54 with a screen 56. A processor and a power source, not shown, are housed within the base to execute game programs. The game programs themselves are typically contained in a game program memory such as, for example, a semiconductor memory (e.g., ROM, EPROM, etc.) that is part of a removable cartridge.

The gaming unit 50 includes first and second controllers 80 and 90 detachably mounted to opposing sides of base 52. The first and second controllers 80 and 90 include a first base interface 84 and a second base interface 94, respectively, each of which detachably couples to first and second controller interfaces 58 and 60, respectively, located on the base 52. When the controllers 80 and 90 are mounted to the base 52, input elements 82 and 92 are in communication with the processer to allow a player to provide input necessary to play a game. In the illustrated embodiments, the input elements 82 and 92 include buttons, joysticks, and bumpers, and directional pads. Various controls 64, such as power and volume are located on the top surface of the base 52. A bottom surface of the base 52 includes a docking interface 62 that enables the gaming unit to be placed in a dock to connect the gaming unit 50 to a television or computer monitor. The dock also provide power to the gaming unit 50 and enables connectivity through various ports, such as HDMI, USB, Ethernet, or other suitable ports.

While known docks can provide improved gaming experiences, they generally do so at the expense of portability. That is, these docks are designed to be coupled to stationary power sources, displays, and input and output devices.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of disclosed portable gaming monitor are suitable for use with a portable video game unit to provide a player with an enhanced gaming experience. The portable gaming monitor uses the controllers of the portable video game unit while providing a larger screen and maintaining the portability of the portable video game unit.

In a disclosed embodiment, a portable gaming monitor is used with a portable video game unit, wherein the portable video game unit includes a base with a first screen, a processor, and a first controller detachably coupled to the base. The portable gaming monitor comprises a housing, a gaming unit dock configured to receive the portable video game unit, and a second screen positioned on the housing, the second screen being operably connected to the portable video game unit when the portable video game unit is received by the gaming unit dock. The portable gaming monitor further includes a first interface configured to detachably coupled the first controller to the housing. The first controller is in communication with the portable video game unit when the first controller is coupled to the first interface, and the portable video game unit when the portable video game unit is received by the gaming unit dock.

In any embodiment, the portable gaming monitor further comprises a first handle detachably mounted to the housing, the first handle comprising a recess configured to at least partially receive a portion of the first controller.

In any embodiment, the portable video game unit further comprises a second controller detachably coupled to the base, the portable gaming monitor further comprising a second interface configured to detachably couple the second controller to the housing, wherein the second controller is in communication with the portable video game unit when the second controller is coupled to the second interface and the portable video game unit is received by the gaming unit dock.

In any embodiment, the portable gaming monitor further comprises a second handle detachably mounted to the housing, the second handle comprising a recess configured to at least partially receive a portion of the second controller.

In any embodiment, the gaming unit dock comprises a base surface, a pair of side walls, a cover rotatably coupled to the base and reciprocal between an open position and a closed position, and a docking interface. The base surface, the side walls, and the cover in the closed position define a cavity. The docking interface operatively engages the portable video game unit when the portable video game unit is disposed within the cavity.

In any embodiment, the portable gaming monitor further comprises a battery strap configured to mount a battery to the housing, the battery providing power to the portable video game unit.

In any embodiment, the portable gaming monitor further comprises a kickstand rotatably coupled to the housing by a frictional hinge.

In any embodiment, the second screen is larger than the first screen.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 shows a known portable video game unit suitable for use with embodiments of the disclosed portable gaming monitor;

FIG. 2 shows the portable video game unit of FIG. 1 with first and second controllers detached;

FIG. 3 shows a front view of a representative embodiment of a portable gaming monitor according to aspects of the present disclosure, wherein the first and second controllers of the portable video game unit of FIG. 1 are positioned to be attached to the portable gaming monitor;

FIG. 4 shows a front isometric view thereof, wherein the first and second controllers are attached;

FIG. 5 shows a rear isometric view thereof;

FIG. 6 shows a rear isometric view thereof, wherein a gaming unit dock of the portable gaming monitor is in a first state;

FIG. 7 shows a rear isometric view thereof, wherein the gaming unit dock is in a second state;

FIG. 8 shows a rear isometric view thereof, wherein the gaming unit dock is in a third state;

FIG. 9 shows a rear isometric view thereof, wherein the gaming unit dock is in a fourth state;

FIG. 10 shows a rear view thereof, wherein the gaming unit dock has a cover with an alternate latch configuration;

FIG. 11 shows a partial rear isometric view thereof, wherein the controllers are detached, and a handle is positioned to be attached to the portable gaming monitor;

FIG. 12 shows a partial front isometric view thereof;

FIG. 13 shows a partial front isometric view thereof, wherein the handle is attached;

FIG. 14 shows rear isometric views of a cover for the gaming unit dock shown in FIG. 10, wherein the gaming unit dock includes an optional battery holder;

FIG. 15 shows rear isometric views of the battery holders shown in FIG. 14, wherein the battery holders are holding two different sized batteries;

FIG. 16 shows a rear isometric view of the portable gaming monitor of FIG. 5, wherein a stand is in an extended position;

FIG. 17 shows a player using the portable gaming monitor of FIG. 3 with the controllers mounted directly thereto; and

FIG. 18 shows a player using the portable gaming monitor of FIG. 3 with the controllers connected thereto by a controller adapter.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “forward,” “rearward,” “front,” “rear,” “upward,” “downward,” “top,” “bottom,” “right hand,” “left hand,” “lateral,” “medial,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. In this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

The following description provides several examples that relate to portable gaming monitors that provide an enhanced gaming experience when used in conjunction with portable gaming units. Embodiments of the portable gaming monitors provide larger screens while maintaining the functionality and portability of the portable gaming units.

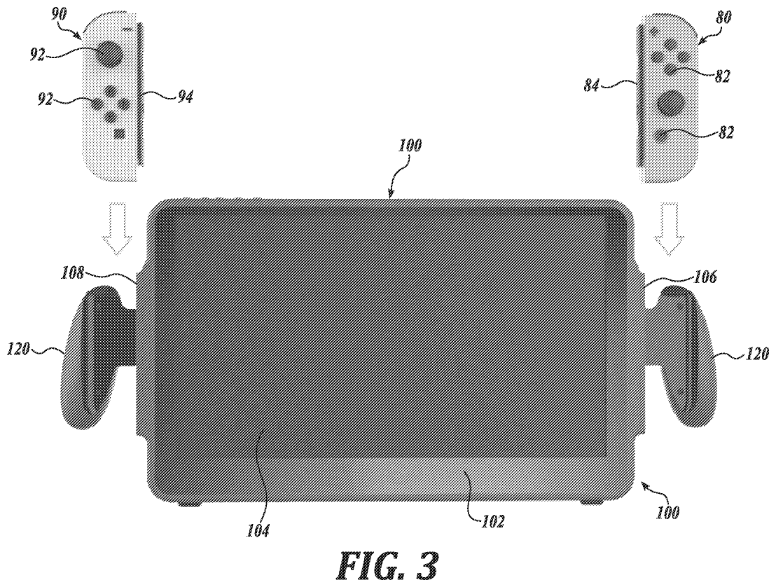

Referring initially to FIG. 3-5, a representative embodiment of a portable gaming monitor 100 (also referred to as “the monitor”) according to aspects of the present disclosure is shown. The monitor 100 includes a housing 102 with a screen 104 positioned on a front side of the housing. In some embodiments, the screen is an LED screen, an LCD screen, or any other suitable display device. In some embodiments, the screen is a “touch screen” to enable player to interact with the game by contacting the screen with one or more fingers, a stylus, or any other suitable input device.

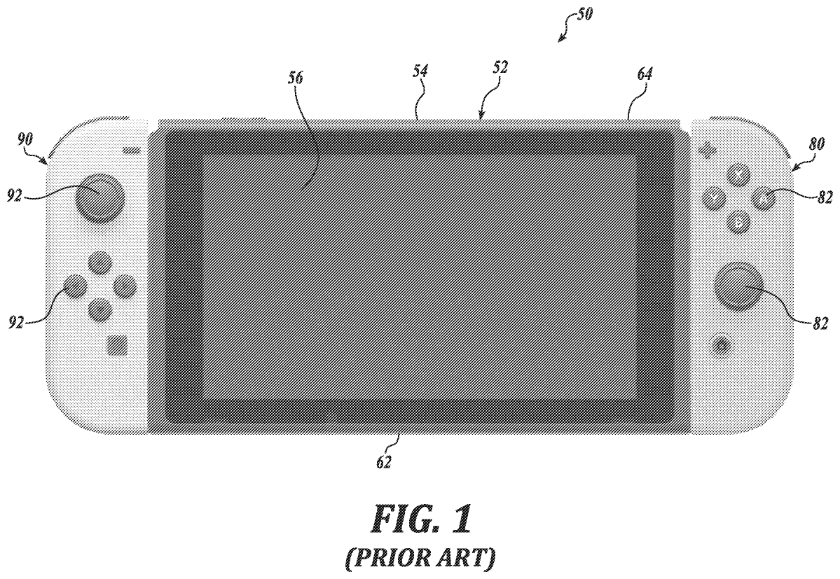

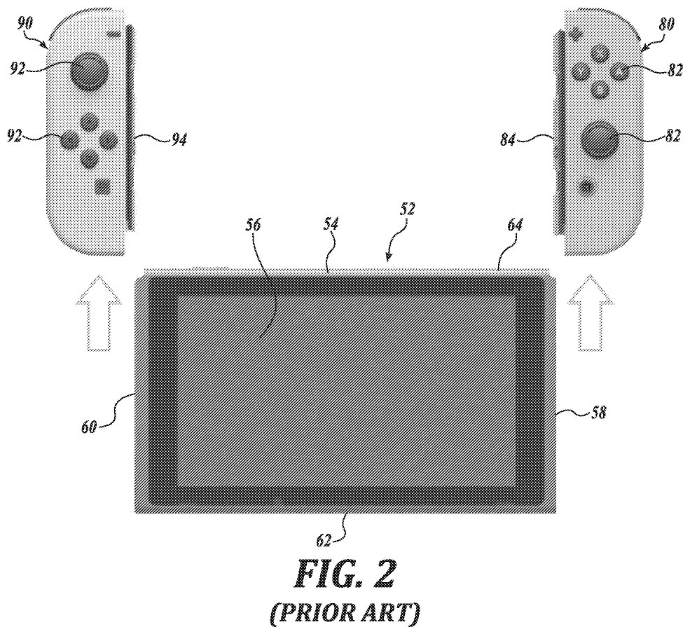

As will be described in further detail, the monitor 100 is configured to have the base 52 and controllers 80 and 90 of the gaming unit 50 detachably coupled thereto so that a player can play the portable video game unit using the controllers 80 and 90 while viewing the game on the screen 104 of the monitor 100. That is, when used in conjunction with a gaming unit 50, such as the one shown in FIGS. 1 and 2, the screen 104 acts as a display for the gaming unit. Because the screen 104 of the monitor 100 is larger than the screen 56 of the gaming unit 50, the player is provided with an enhanced gaming experience.

In the illustrated embodiment, the housing 102 has a generally rectangular shape and is formed from injection molding a thermoplastic material, such as Acrylonitrile Butadiene Styrene (ABS). In some embodiments, the housing has any suitable shape, including different profiles and thicknesses, and is formed of any suitable material or combination of materials by any suitable manufacturing process. In this regard, the disclosed housing 102 is exemplary only and should not be considered limiting.

The housing 102 has a first controller interface 106 and a second controller interface 108 positioned on opposite ends of the housing. The first and second controller interfaces 106 and 108 are similar to the first and second controller interfaces 58 and 60, respectively. In this regard, the first and second controller interfaces 106 and 108 are configured to slidably receive the first and second controllers 80 and 90, respectively, to detachably couple the controllers to the housing 102. When coupled to the housing 102, the controllers 80 and 90 are in communication with the gaming unit 50 so that a player can use the controllers 80 and 90 to provide input necessary to play video games on the gaming unit.

A pair of handles 120 are mounted to the housing 102, each handle being proximate to one of the first and second controller interfaces 106 and 108. Each handle 120 has a recess sized and configured to receive the corresponding controller when the controller is coupled to the housing. The handles 120 and controllers 80 and 90 are configured so that when the controllers are installed, a player can hold the monitor 50 by the handles 120 while providing input to the controllers 80 and 90 to play video games on the gaming unit.

In the illustrated embodiment, the controllers 80 and 90 are slidably received by the housing to mount the controllers thereto, however, it will be appreciated that in some embodiments, the first and second controller interfaces 106 and 108 can vary to accommodate controllers from different gaming units. Further, in some embodiments, the controllers are mounted to interfaces that are not part of the base 102 but are themselves connected to the base by wired or wireless connection. In some embodiments, the first and second controllers are mounted to a base to simulate a console-type game controller that is itself operably connected to the gaming unit by wire or wireless connection.

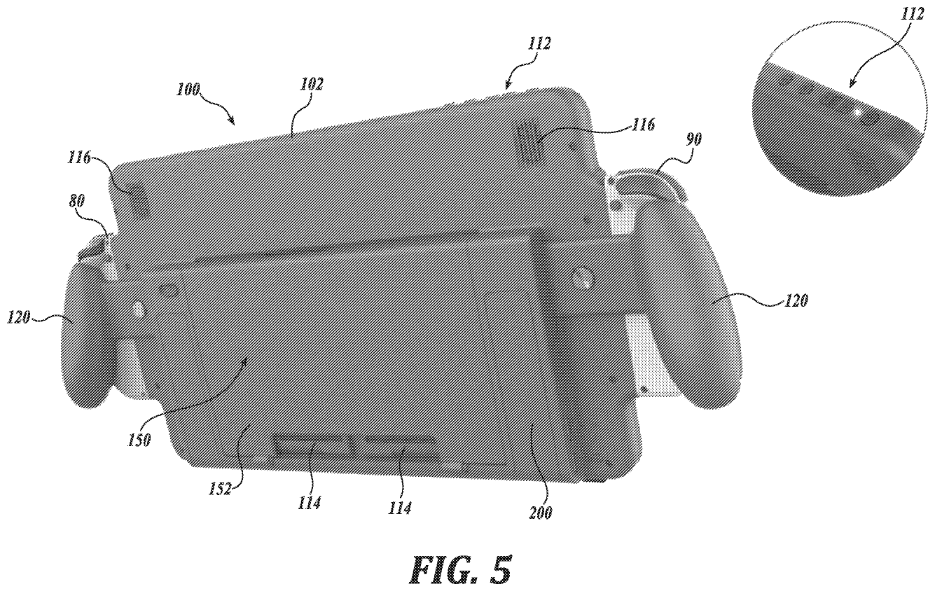

As best shown in FIG. 5, the housing 02 includes a plurality of function elements 112 configured to control various aspects of the gaming monitor 100. In some embodiments, the function elements 112 enable a player to control one or more of power, volume, screen brightness, screen contrast, or any other function of the gaming unit 50 and/or gaming monitor 100. In some embodiments, the function elements provide input our output capabilities, including audio out; video in or out; USB, HDMI, or ethernet connectivity; or any other suitable input our output interfaces.

The back of the housing 102 includes one or more air inlets 114 and one or more cooling fans 116. The cooling fans 116 draw air in through the air inlets 114 through the interior of the housing 102 to cool components of the gaming monitor 100 and the gaming unit 50 docked therein. In some embodiments, the number and location of the air inlets 114 and cooling fans 116 differ from the illustrated embodiment.

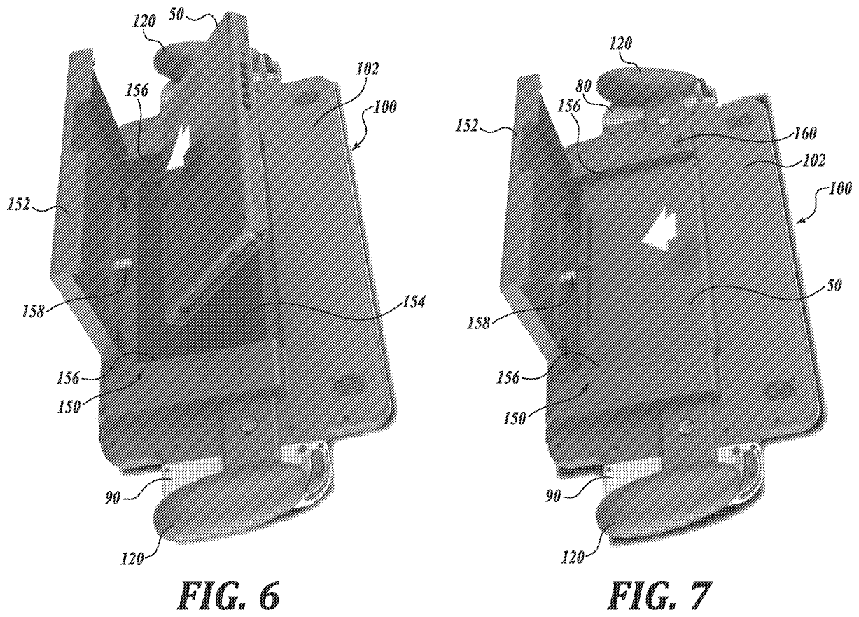

Referring now to FIGS. 6-9, the gaming unit dock 150 receives and secures the gaming unit 50 to operably connect the gaming unit to the monitor 100. With the gaming unit 50 docked in the gaming monitor 100, components of the gaming monitor are in communication with the gaming unit so that a player can provide input to the gaming unit via gaming monitor components. Further, the gaming monitor 100 receives output signals from the gaming unit 50 that the gameplay is displayed on the screen 104 of the monitor 100. In some embodiments, the monitor is also configured with speakers, haptic feedback, or any other suitable components to provide feedback from the gaming unit 50.

The gaming unit dock 150 includes a cover 152 hingedly coupled to the back of the monitor 100. The gaming unit dock 150 further includes a generally flat base surface 154 and corresponding side walls 156. When the cover 152 is closed, the cover, the base surface 154 and the side walls 156 cooperate to define a cavity sized to retain the gaming unit 50 therein. The gaming unit dock 150 further includes a docking interface 158 that engages a corresponding interface on the gaming unit 50 to place the gaming unit in operable communication with the monitor 100. In the illustrated embodiment, the docking interface 158 is a USB-C male connector that engages a corresponding USB-C female connector in the gaming unit 50. It will be appreciated that the docking interface 158 is exemplary only, and any suitable interface corresponding to the interface of the gaming unit 50 can be included. In some embodiments, the docked gaming unit 50 communicates with the monitor wirelessly via BLUETOOTH®, Wi-Fi®, or other suitable networking technology.

The process for docking the gaming unit 50 will now be described with reference to FIGS. 6-9. In FIG. 6, the cover 152 of the gaming unit dock 150 is open, and the gaming unit 50 is positioned so that the sides of the gaming unit are aligned with the side walls 156 of the gaming unit dock 150. The gaming unit 50 is then positioned against the base surface 154 between the side walls 156, as shown in FIG. 7. In some embodiments, the base surface 154 is covered with felt or another soft material to protect the screen 56 of the gaming unit 50. When the gaming unit 50 is positioned as shown in FIG. 7, the side walls 156 prevent lateral movement of the gaming unit and maintain the alignment of the gaming unit relative to the monitor 100 and by extension, the docking interface 158 relative to the corresponding interface on the gaming unit.

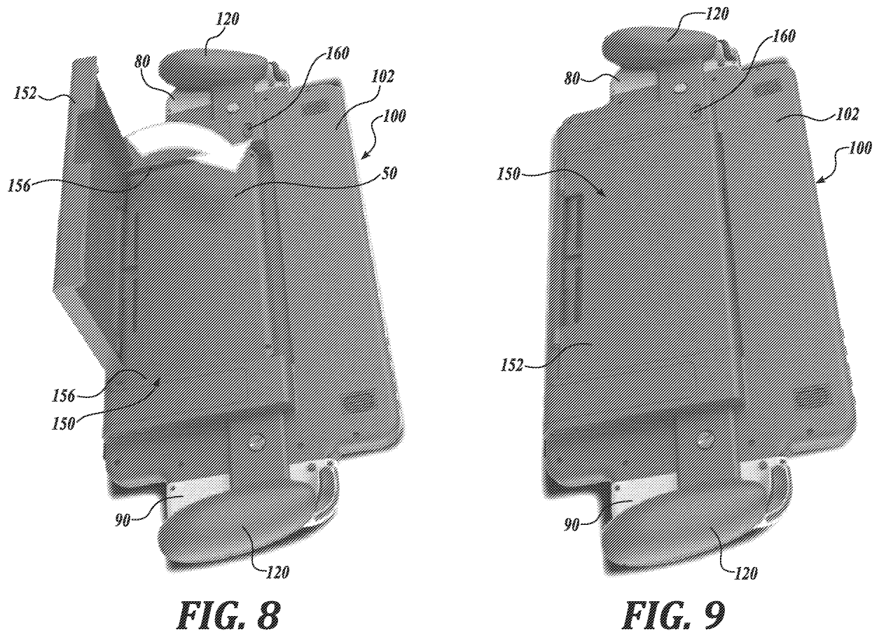

Referring now to FIG. 8, the gaming unit 50 is moved along the base surface 154 to engage the docking interface 158. With the gaming unit 50 engaged with the docking interface 150, the cover 152 is rotated to the closed position shown in FIG. 9 and secured in place with a latch 160. In some embodiments, the deformable elastic spacers are included on an inner surface of the cover 152. When the cover 152 is closed with the gaming unit 50 in a docked position, the elastic spacers engage the gaming unit to further restrain the gaming to ensure that the gaming unit does not move within the cavity of the gaming unit dock 150.

To undock, i.e., remove, the gaming unit 50 from the monitor 100, the docking procedure is reversed. That is, latch 160 is released, the cover 152 is opened, the gaming unit 50 is slid along the base surface 154 to disengage the docking interface 158 from the gaming unit, the gaming unit is moved away from the monitor, and the cover is closed.

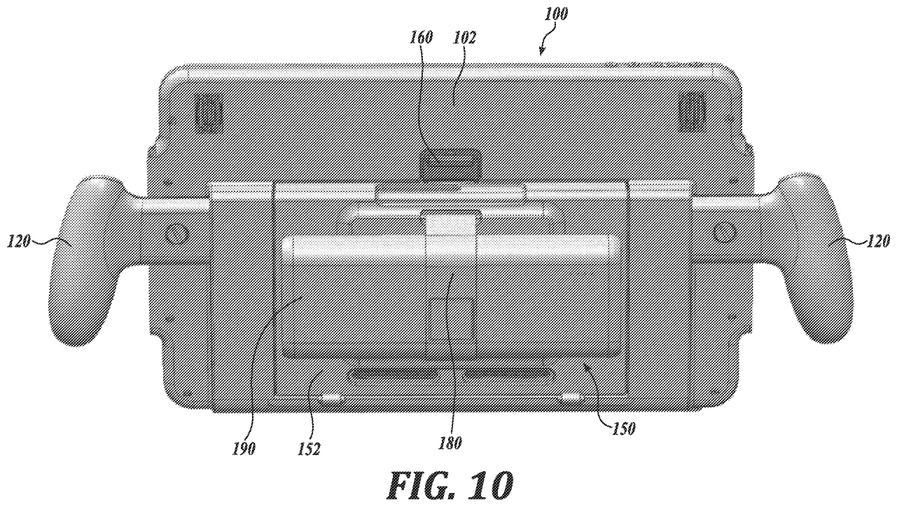

It will be appreciated that the illustrated gaming unit dock 150 is exemplary only and should not be considered limiting. In some embodiments, the size, shape, and location of the cover, and therefore, the gaming unit dock 150, are different to accommodate different gaming units. In some embodiments, the cover 152 includes a biasing element, such as a spring, to bias the cover toward the open position or the closed position. In some embodiments, the location and configuration of the latch 160 may vary. FIG. 10 shows an alternate latch 160 configuration in which the latch is centrally located along an edge of the cover 152. These and other variations to the gaming unit dock 150 are contemplated and should be considered within the scope of the present disclosure.

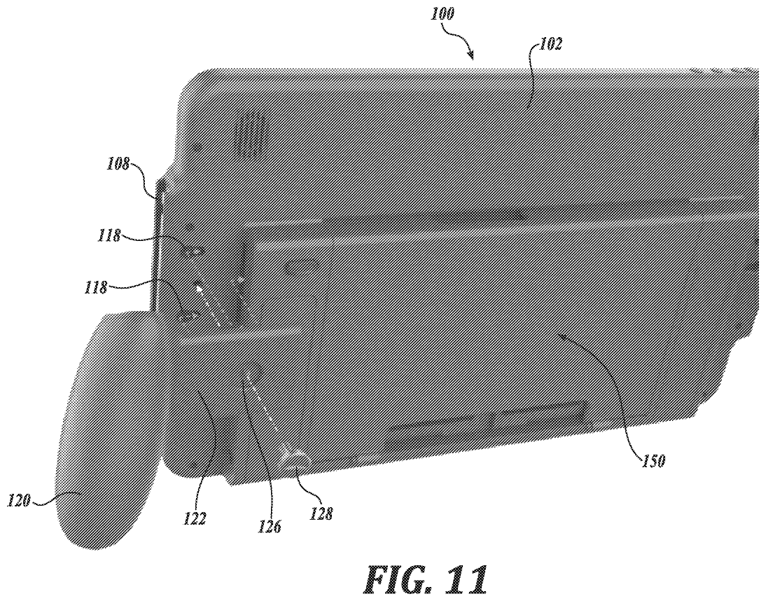

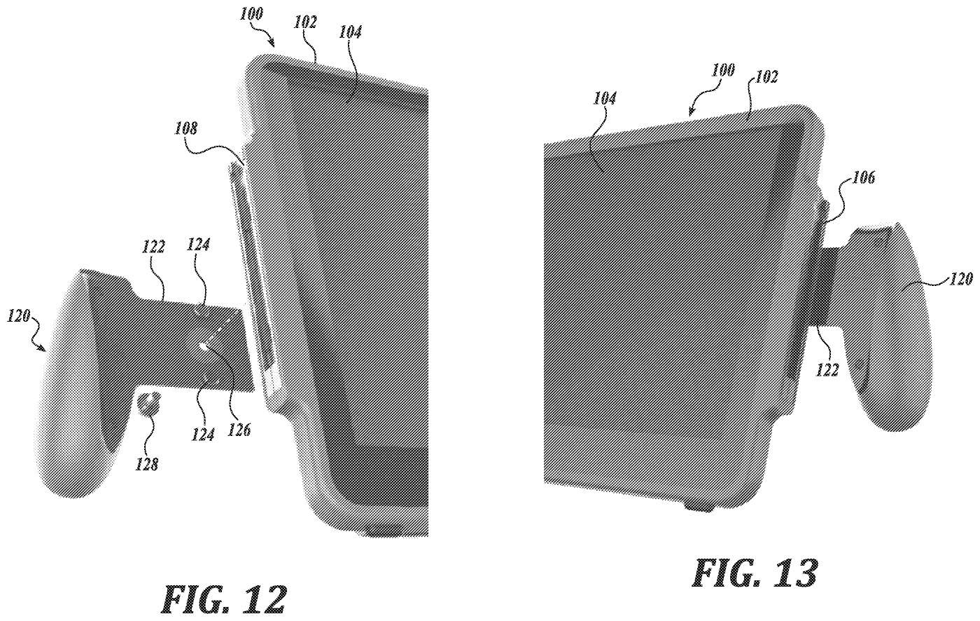

Referring now to FIGS. 11-13, the handles 120 are detachably coupled to the monitor 100 to enable a player to utilize the monitor with or without the handles according to the games being played and player preference. The detachable nature of the handles 120 also enables a player to selectively attach different handles configured to suit different games and/or player preferences. In the illustrated embodiment, the handles 120 and their attachment features are mirror images of each other and will be described with understanding that the description of one handle also applies to the description of the other handle. It will be appreciated, however, that the handles need not be mirror images of each other, and in some embodiments, the size, configuration, and attachment features may vary between the handles to accommodate functional and/or aesthetic considerations.

The handle 120 includes a mounting feature 122 that engages the monitor 100 to demountably couple the handle to the monitor. In the illustrated embodiment, the mounting feature 122 is a flat, generally rectangular feature that extends inwardly from the portion of the handle that a player holds. One or more tabs 124 are disposed on the surface of the mounting feature 122 and are sized and configured to be slidingly received by corresponding slots 118 in the monitor 100. With the tabs 124 engaging the slots 118, movement of the handle 120 relative to the monitor 100 is limited to transition in the lateral direction. A fastener 128 is installed through an aperture 126 in the mounting feature 122 and threadedly engages a corresponding hole in the monitor 100 to prevent lateral movement of the handle 120 relative to the monitor. In some embodiments, the fastener 128 is selectively removable by a player without the use of a screwdriver, for example by using a quarter or not using a tool at all.

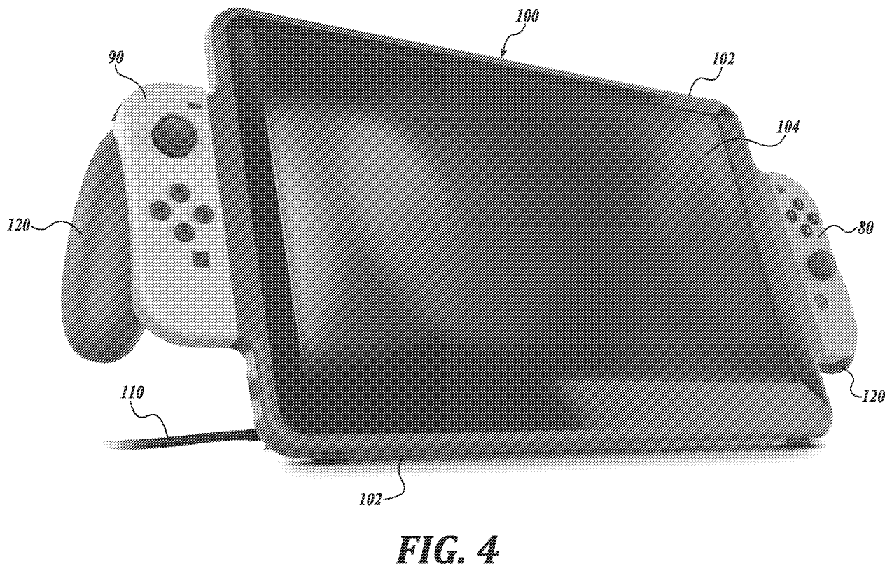

Referring back to FIG. 4, some embodiments of the monitor 100 include a power cord 110. The power cord 110 is configured to be connected to an external power source (not shown), such as an outlet, a battery, or any other suitable power source. In some embodiments, the external power source provides power to operate the screen 104 of the monitor. In some embodiments, the external power source provides power to operate and/or recharge the battery of the gaming unit 50.

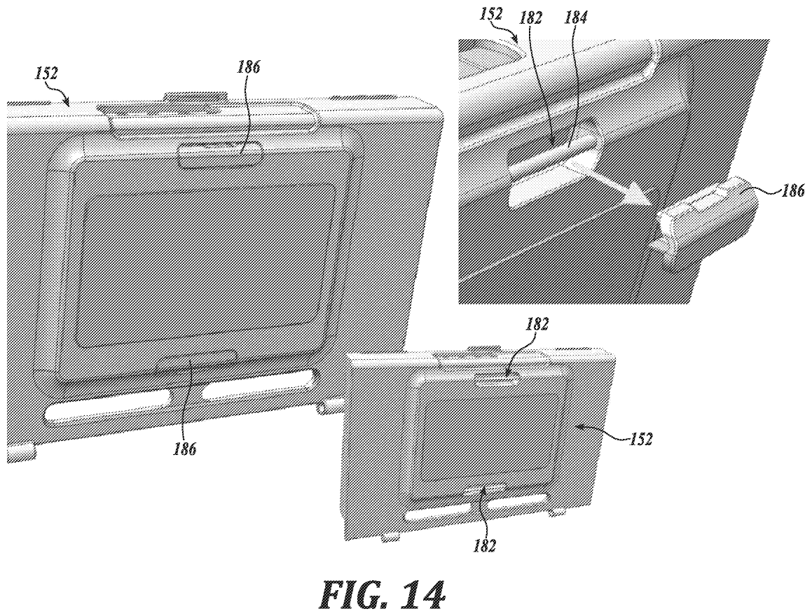

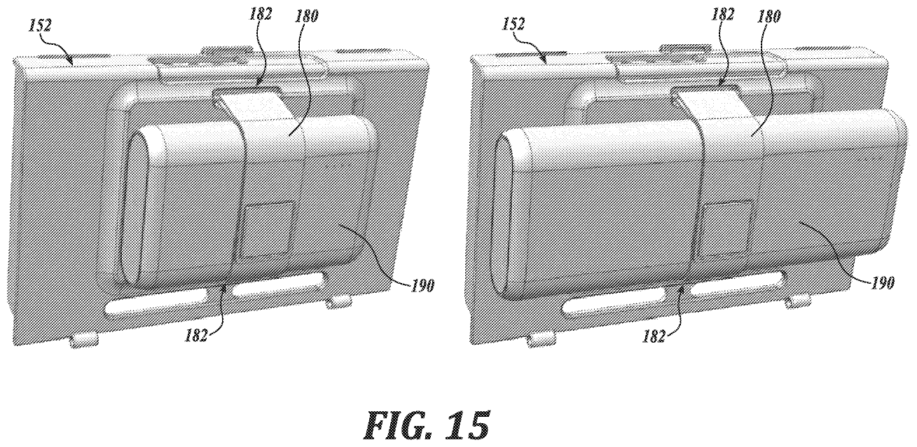

As best shown in FIGS. 14 and 15, some embodiments of the monitor 100 include a battery strap 180 configured to secure a battery 190 to the monitor 100. In some embodiments, the battery 190 is connected to the monitor 100 and serves as a power source for both the gaming unit 50 and the monitor. When so configured, a player can play games completely untethered from fixed external power sources. In some embodiments, the battery 190 is a rechargeable power bank. In some embodiments, the battery has a capacity in the range of, for example, 300 mAh to 20,000 mAh or more. In some embodiments, the battery voltage is between, for example, 3.7 volts and 14.4 volts. It will be appreciated that the present disclosure is not limited to a particular battery or battery type, and any suitable battery or power storage device can be used.

In the embodiment of FIGS. 14 and 15, a strap 180 secures the battery 190 to the monitor 100. More specifically, the strap 180 secure the battery to the cover 152 of the gaming unit dock 150. Each end of the strap 180 is attached to the cover 152 at a strap interface 182. As best shown in FIG. 14, the strap interface 182 includes a recess and a pin 184 extending across the recess. Each end of the strap 180 includes a loop through which the pin 184 extends (like the end of a watch band) to rotatably secure the end of the strap to the cover 152. In some embodiments, a cover 186 is inserted into the recess when the strap 180 is not attached to the cover 152.

As shown in FIG. 15, the strap 180 can be adjusted to mount different sized batteries to the monitor 100. In some embodiments, two or more straps are included. In some embodiments, the straps are attached to the monitor 100 by snaps, clips, hook and loop fasteners, or any other suitable mechanism. In some embodiments, strap is formed from an elastic material. In some embodiments, the strap is a two-pieces strap, wherein the ends of the two pieces are secured to each other by a buckle, hook and loop fasteners, or any suitable method. In some embodiments, the strap is secured to any suitable portion of the monitor.

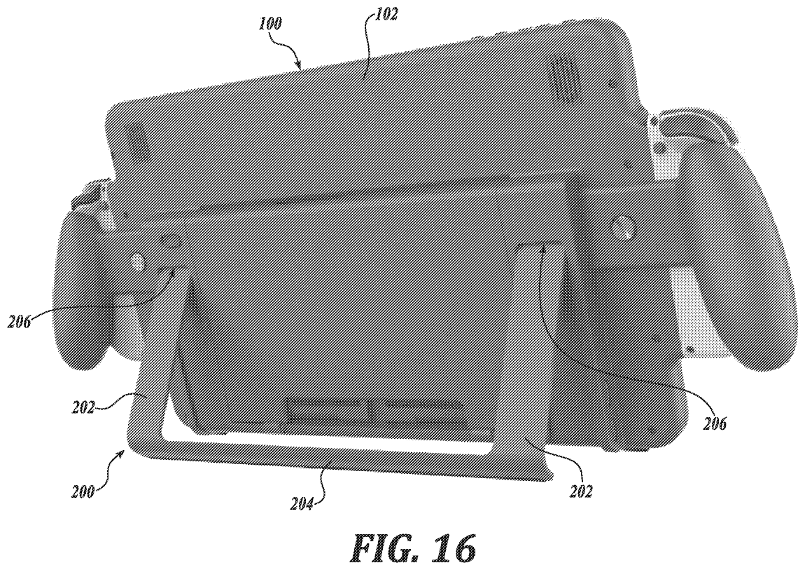

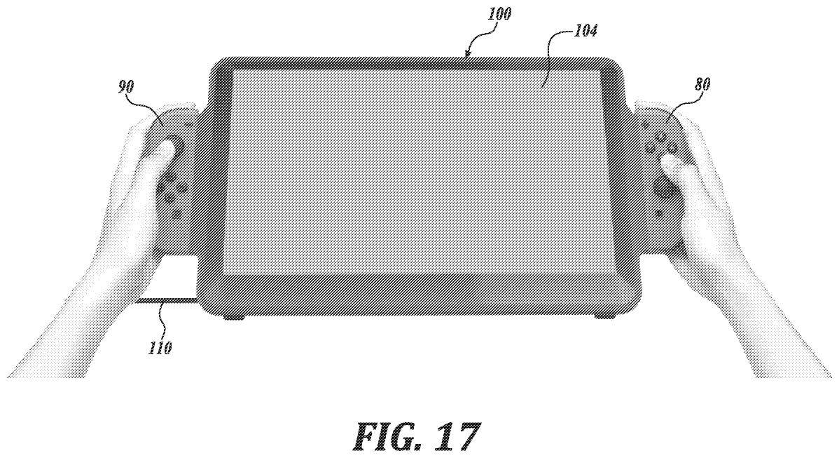

Referring now to FIGS. 5 and 16, the monitor 100 includes a kickstand 200 that enables a player to position the monitor on a surface in a suitable position. The kickstand 200 includes a pair of vertical legs 202, each of which is rotatably coupled at a first end to the monitor 100 by a hinge 206. The second ends of the vertical legs 202 are connected by a horizontal base 204. When the kickstand 200 is in a stowed position, as shown in FIG. 5, the stand is positioned within a recess in the back of the monitor 100 so that the stand is flush with the back of the monitor. When the kickstand 200 is extended, as shown in FIG. 16, the kickstand extends from the back of the monitor 100 at an angle so that the monitor can be positioned on a surface in angled orientation. In some embodiments, the hinge 206 is a frictional hinge that enables the kickstand 200 to be maintained by friction at any angle within a predetermined range. In some embodiments, rubber feet are positioned on the bottom of the kickstand 200 and the housing 102 to prevent the monitor from slipping on smooth surfaces.

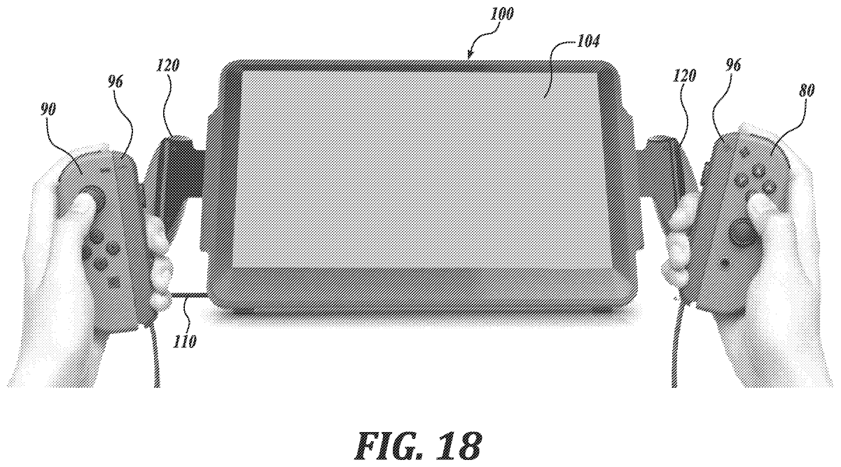

FIG. 17 shows a player using the monitor in a first configuration, wherein the controllers 80 and 90 are directly mounted to the monitor 100. The player holds the monitor 100 by the handles 120, which positions the players thumbs proximate to the controllers 80 and 90, similar to the gameplay in the gaming unit 50. In another embodiment, shown in FIG. 18, the controllers 80 and 90 are coupled to a controller adapter 96 that is itself in communication with the monitor 100. The adapter 96 allows the player to use the controllers 80 and 90 in a manner in which the controllers are not fixedly positioned relative to the monitor 100 or relative to each other. These and other controller adapters suitable for use with known gaming units can by utilized in conjunction with the monitor 100 and should the use of such adapters should be considered within the scope of the present disclosure.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A portable gaming monitor for use with a portable video game unit, the portable video game unit including a base with a first screen, a processor, and a first controller detachably coupled to the base, the portable gaming monitor comprising:
a housing;
a gaming unit dock configured to receive the portable video game unit,
a second screen positioned on the housing, the second screen being operably connected to the portable video game unit when the portable video game unit is received by the gaming unit dock; and
a first interface configured to detachably coupled the first controller to the housing, wherein the first controller is in communication with the portable video game unit when the first controller is coupled to the first interface, and the portable video game unit when the portable video game unit is received by the gaming unit dock.

2. The portable gaming monitor of claim 1, further comprising a first handle detachably mounted to the housing, the first handle comprising a recess configured to at least partially receive a portion of the first controller.

3. The portable gaming monitor of claim 1, wherein the portable video game unit further includes a second controller detachably coupled to the base, the portable gaming monitor further comprising a second interface configured to detachably couple the second controller to the housing, wherein the second controller is in communication with the portable video game unit when the second controller is coupled to the second interface and the portable video game unit is received by the gaming unit dock.

4. The portable gaming monitor of claim 1, further comprising a second handle detachably mounted to the housing, the second handle comprising a recess configured to at least partially receive a portion of the second controller.

5. The portable gaming monitor of claim 1, wherein the gaming unit dock comprises:
a base surface;
a pair of side walls;
a cover rotatably coupled to the base and reciprocal between an open position and a closed position; and
a docking interface,
wherein the base surface, the side walls, and the cover in the closed position define a cavity, the docking interface operatively engaging the portable video game unit when the portable video game unit is disposed within the cavity.

6. The portable gaming monitor of claim 1, further comprising a battery strap configured to mount a battery to the housing, the battery providing power to the portable video game unit.

7. The portable gaming monitor of claim 1, further comprising a kickstand rotatably coupled to the housing by a frictional hinge.

8. The portable gaming monitor of claim 1, wherein the second screen is larger than the first screen.
